(19) United States
(12) Patent Application Publication
(10) Pub. No.: US 2019/0319948 A1
(43) Pub. Date: Oct. 17, 2019

(54) REMOTE AUTHENTICATION AND IDENTIFICATION PROOFING SYSTEMS AND METHODS

(71) Applicants: C. Richard Triola, Laguna Beach, CA (US); David Kressel, Los Angeles, CA (US); Timothy Lai, Westlake Village, CA (US)

(72) Inventors: C. Richard Triola, Laguna Beach, CA (US); David Kressel, Los Angeles, CA (US); Timothy Lai, Westlake Village, CA (US)

(73) Assignee: SETTLEWARE SECURE SERVICES, INC., LAGUNA BEACH, CA (US)

(21) Appl. No.: 15/950,849

(22) Filed: Apr. 11, 2018

(51) Int. Cl. H04L 29/06; H04L 9/32

(52) U.S. Cl. CPC H04L 63/0861; H04L 9/3218

(57) ABSTRACT

A remote notary system, authentication, and identity proofing system is disclosed that is allows documents to be notarized and witnessed online. In some embodiments, more than one signatory or observers may be included in a remote notary session at the same time.

### BACKGROUND OF THE INVENTION

### 1. Field of the Invention

The present invention generally relates to electronic transactions, and more particularly to remote notary, authentication, identification (ID) proofing, and other associated methods, systems, and apparatus.

### 2. Background

Notaries have been around for some time. Notaries are invaluable for certain transactions to confirm that parties signing documents in a transaction are true and the intended signers. Typically, a party wanting to sign a document will make a physical appearance at a notary's office or the notary will travel to a place specified by one or more parties. The notary will verify the identity of the signatory and then the notary will add his or her seal to the signed document. Additionally, the notary may have a log book with an entry for the person's name, identification information, and other information about the transaction.

This basic process is cumbersome and requires persons involved in the transaction to travel, meet at certain locations at specified times, and requires that the notary or the signatory or both to bring several documents with them and ensure that they are kept safe. Additionally, in many cases, identification, such as a driver's license may not be sufficient and the notary is usually not trained to determine if the identification is fake. This means that the notary may not be secure.

Transactions are prevalent online. People are able to conduct banking, purchase goods, and exchange information over a network, such as the Internet. Several systems are known that allow for the exchange of and execution of documents. However, known systems suffer from several drawbacks. For example, known systems do not use sufficient identity proofing to confirm the identity of a person over the Internet. Moreover, known systems do not have sufficient security to ensure that the document, the signatures, and notary seal is authentic.

Other problems with known systems include providing a remote notary with the ability to support different device types, such as desktop or mobile with different operating systems. Additionally, providing notifications of meeting, users, status of document, payment, and queuing and wait time notification may also be challenges.

Moreover, the dynamic presentation of ID verification tools based on factors such as location, citizenship, documentation available, requesting/receiving party data availability, requesting/receiving party requirements are challenges with current systems. In addition, in many systems, authentication tools are not static and/or dynamic and the identity proofing does not use multi-factor identity proofing where more than one level of authentication is available.

The ability to process notaries remotely over a communications link also has its challenges. For example, secure connections are required between the user and the notary, and the user needs to be authenticated by a computerized process using randomized questions from a user's background, data from third party databases, biometrics, chip-based technology. Additionally, there is a need to use online computerized processes and systems to perform identity proofing remotely and securely with one or more multiple levels of online security. The notary also needs computerized methods to issue notary seals and maintain electronically notary information is a ledger. Each of these computerized processes need to be integrated between and among various systems and computers in a specialized way to conduct an online, secure notary process that includes several computer-centric issues not found in conventional in person notaries related to remote authentication, remote identity proofing, security, and sealing, and delivering executed and/or sealed documents.

Accordingly, there is a need for a remote notary, authentication, identification (ID) proofing, and other associated methods, systems, and apparatus that takes advantage of the computerized authentication, identification, and security protocols in order to conduct notary transactions.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates a system for performing remote notary in an embodiment.

FIG. 2 illustrates a flow chart for a remote notary session in an embodiment.

FIGS. 3A-3I show screen shots for a remote notary session.

FIGS. 4A-4S show various flow diagrams showing computerized routines related to different aspects of a notary session.

### DETAILED DESCRIPTION

Each of the additional features and teachings disclosed below can be utilized separately or in conjunction with other features and teachings to provide a device, system, and/or method for remote notary. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Devices, methods, and systems are described for remote notary. It should be noted that other types of transactions may also be performed using the techniques and methods described herein. For example, the disclosed identity proofing may be used by banks to confirm the identity of an individual, or used to communicate with and/or onboard new accounts In one embodiment, the remote notary may be conducted over any network, such as a private network or the Internet, using any communication technologies, such as the Institute of Electrical and Electronics Engineers (IEEE) 802.11 system and the Three Generation Partnership Project (3GPP), and Long Term Evolution (LTE) standard. It should be noted that references to user and signatory are meant to include anyone using the remote system. Moreover, a “notary seal” is meant to refer to a stamp of the notary or other display or indicia conveying notary information. A “notary” is a person or an automated process for performing a notary session and/or applying a notary seal. It should also be noted that the remote notary system may also be used to witness a transaction associated with an electronic document and the notary may be optional. It should also be noted that the sessions and transactions described herein can be applied any type of transaction, including, but not limited to, real estate, legal, financial, contract, mortgage, surety, trusts, and wills. Additionally, any other transaction that may use electronic documents and signatures may use the systems and methods described herein.

It should also be noted that references to “signature” or “electronic signature” are meant to refer to symbols or other data in digital form attached to an electronic document. It should also be noted that references to “digital signature” are meant to refer to a small block of data that is attached to an electronic document that is generated from digital identification. The digital signature may include a private and public key. The private key may be used to apply the digital signature to the document. The public key may include encrypted code that verifies an identity of a signatory. It should also be noted that references to “document” or “electronic document” are meant to refer to any record, contract, or other paper that is created, stored, transmitted, or received electronically.

Digital signatures may be used to certify or approve electronic documents and show that the electronic document has not been altered since it was signed. Other security methods may be used to tamper seal documents. It should also be noted that references to “notary” or “remote notary” are meant to refer to an application run on a processor and containing code to enable substantially real time or real time notarization over a network. It should also be noted that a notary may be replaced by any person or entity acting as an agent, consultant, legal representative etc. that is involved in consummating a transaction. It should be noted that the term “transaction” means an action or set of actions that occur between two or more parties.

The remote notary may apply the signature and run all processes and methods associated with a notary such as certain legal formalities, including certifying contracts, deeds, wills, power of attorney (POA) documents, and other documents for use in other jurisdictions. A signature may be made via a processor. In one embodiment, the remote notary may operate as a custodian of the documents, providing safe harbor of original executed documents and attest to originality, authenticity, and the like. The documents may also be stored securely and electronically in a database.

In one embodiment, the remote notary may include scanning technology that may be used to authenticate an uploaded form of identification, such as a driver's license or a passport or other similar issued identification. In one embodiment, the remote notary may also include knowledge-based questioning or authentication, such that questions are posed to the signatory that are personal to the signatory. Blockchain may also be used for authentication in some embodiments. “Blockchain” may refer to a decentralized, distributed, digital ledger that is used to immutably record transactions and events across and among many computers. A record in the ledger and its authenticity may be verified by using the blockchain. A blockchain hash may be added to a document for verification. Real-time Speech and emotion sentiment analysis of audio-video stream, during session, to prevent signing under duress may also be used

The knowledge-based questions may be static or dynamic. The remote notary may also include identity proofing using biometric information, such as fingerprinting, eye scans, voice and face recognition, identity management, multi-factor identity proofing where more than one level of authentication occurs either in a notary session or over multiple notary sessions, artificial intelligence, machine learning tools and algorithms, IP addresses, and GPS and geo-location tools. The remote notary may also use data from other sources, such as online records, social media and networking, credentials, and the like. In one embodiment, the remote notary may be configured to provide a unique digital notarization identification (NID) to an individual. In one embodiment, the NID may include a token, photo, or digital identifier that may be stored in a database. When the remote notary receives NID, the remote notary may have configured to compare the received NID with the stored NID to authenticate and/or identify an individual.

The remote notary may include electronic or digital signatures to sign one or more documents. The signatures may include one or more font options or image of the actual representative signature and may be saved or uploaded. In one embodiment, the document may include any document that may be signed electronically and/or notarized electronically. In other embodiments, the document may include a combination of font options and actual representative signature on the same document.

The remote notary may be configured to allow more than one party to sign a document at a time. In other embodiments, more than one document may be presented to multiple parties at the same or different locations for signature. In one embodiment, there may be a synchronized page view of the document between the parties. Additionally, the remote notary may include real-time or substantially real-time synchronization when changes are made to the document. The remote notary may also include an electronic notary journal, that tracks payment, IP address of the signatory, name of the signatory, recording, identity information, date and time, document description, completed document, blockchain/distributed ledger, and other identification information. The notary processes and systems may also include an online PDF editor to notarize, seal, and/or sign the electronic document.

The remote notary session may be conducted in one embodiment as follows. It should be noted that one or more steps may be performed and may be performed in any order. In one embodiment, the systems and methods disclosed herein may be performed in all or in part using any combination of devices that are in data communication, such as a laptop, desktop, mobile device, tablet, or the like. In one embodiment, a document requiring notarization and supporting documents are received and/or uploaded.

In an embodiment, the system may serve one or more knowledge-based questions (KBA) to one or more signatories. The KBA may be conducted automatically once the login and password are authenticated. The KBA may also be executed based on the occurrence of an event that is manual, semi-manual, or automatic. In an embodiment, the number of questions for the KBA may be any number. A passing score of the KBA may be either a fixed number or percentage, a dynamic number or percentage, or based on a scoring system that weights different questions or answers differently.

Once the KBA is passed, a notary may be invited to or may already be present in a real-time or substantially real-time session. In one embodiment, the user may again be authenticated using another identity proofing process, such as 3^{rd} party credential analysis, biometrics, fingerprint, retinal scan, artificial intelligence and the like. In one embodiment, the session may be recorded. In one embodiment, the document may be electronically and/or digitally signed. In one embodiment, a tamper proof or tamper evident notary seal may be applied to the executed document. In one embodiment, the digital signature and/or the notary seal or any other certification method may be imported or integrated from a third party. In one embodiment, a payment may be accepted by the system. Once the payment is processed, the document may be electronically sent to the signatory or other recipient and/or the recorded session may be stored along with the document, metadata about the transaction, such as time, date, type of transaction, and audit trail, in the notary journal database or blockchain. In other embodiments, the document may be deposited into an account associated with the signatory or other recipient.

In another embodiment, the remote notary may receive one or more documents, electronically tag documents for signature or initials or other requirement, schedule appointment or meet on-demand over a network with one or more parties; enable a secure online environment or portal for review, editing, approving, and/or signing the document, provide identification verification and/or proofing, enable audio and/or visual recording, support one or more document formats, execute a document, provide for tamper sealing the document, and/or register the document with a third party registration system or ledger. In one embodiment, a lender may sell or transfer ownership to an investor, which would change the beneficial ownership and reflected in such registration system.

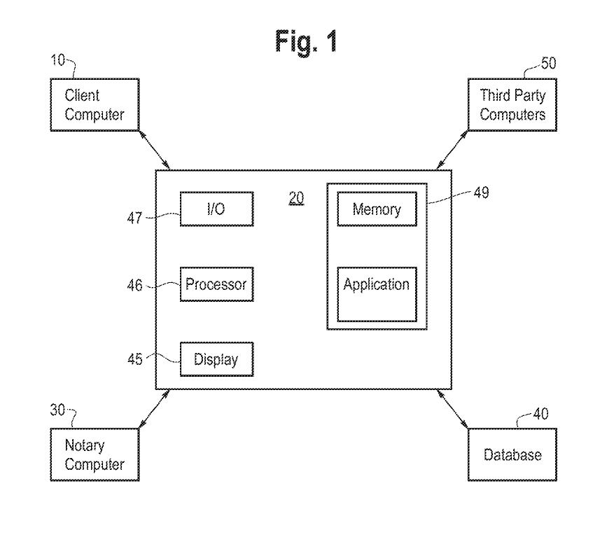

FIG. 1 shows a remote notary system in an embodiment. The system may include a client computer 10, a remote notary system or apparatus 20, a notary computer 30, and third-party computers 50. The system 1 may include one or more client computers 10 and/or notary computers and each client computer 10 and notary computer 30 may include a memory, processor, and hardware for accessing a network, such as the Internet. The client computer 10 and notary computer 30 may be a desktop computer, a PDA, a mobile device, a laptop, or a tablet. The computers 10, 20 and 50 may include audio and video equipment that may be used to provide a virtual, real-time remote notary session.

The remote notary 20 may be accessed by computers 10, 30, and 50 over any private or public network, such as the Internet. In one embodiment, the remote notary 20 may be coupled to one or more servers that run application code to execute a remote notary session 50. The application code may include one or more components to run webRTC to enable real-time video/audio interactions. Other audio and/or video protocols may also be used. In one embodiment, webRTC media servers may be deployed. In another embodiment, application code may be configured for submitting, registering, transferring, recording submitting and/or storing transaction-related data, such as transaction ID, document ID and metadata (date and timestamp, author/owner) in a blockchain or other similar cryptography enabled digital ledger platforms. In another embodiment, artificial intelligence or machine learning may be included to further automate ID verification tasks, such as facial recognition, iris recognition, fingerprint, finger vein recognition, and other forms of biometric authentication. In other embodiments, chatbots or other operations of the remote notary process may be performed automatically without human intervention. In other embodiments, one or more of the methods and steps of the remote notary may be performed automatically without human intervention. In some embodiments, some or all of the application code and steps and methods and communications performed herein may be operated on a standalone kiosk. It should be noted that any or all parts of the system may be used to execute a notary session. In other embodiments, healthcare identification proofing systems may use the systems and methods disclosed herein. In other embodiments, a notarized identification may be created using a notary process, thereby producing a notarized credential for later use.

The remote notary system 20 may include a display 45, a processor 46, input/output devices 47, and a memory 49. A database 40 may be coupled to the system 20. The remote system 20 may include application code 55 that when executed performs instructions described herein to perform the methods and operations for phases one to three described herein. The application code may be stored in the memory 49. Moreover, the application code is executed to run a remote notary session between one or more signatories and one or more notaries to electronically or digitally sign and/or notarize a document. The database 40 may store information concerning the notary, the signatories, and/or the documents to be executed. In some embodiments, the database 40 may include the number of KBA attempts and/or results, artifacts related to ID proofing, such as images of driver's license or passport, utility bills, and results of a check on photo ID. Additionally, the database 40 may include users, roles, permissions, transaction history, document history, transaction status, document status, supporting document relationships, user authentication and token, relationships between parties, ID verification results, actions of users, audio and video recordings, analytics and metrics of session activities, user location, browsers, devices, platforms of users, payment information (type, amount, user), API hooks, multiple signature types, personalized view settings, images of the document's pages, the actual notarized document, document metadata (size, page count, type etc.), client source, document ownership, and/or document uploader. An API hook may refer to code blocks that enable access to a different code module. In one example, the database may include a “hook” for API users to access and respond with their desired action, such as redirect or perform a subsequent action depending on what the hook is.

The database 40 may be integrated with or coupled to the system 20. The remote notary 20 may include audio and video technology to record any or all of a remote notary session. The session may be stored and accessed for later use. The session may be recorded in real time or substantially real-time.

The third-party computers 50 may include access to information, such as credit reporting agencies, identification services, government agencies, social networks, biometric agencies, ID issuing services, corporate databases, fraud detection services, video processing agencies, storage and handling, and/or third party digital signing tools.

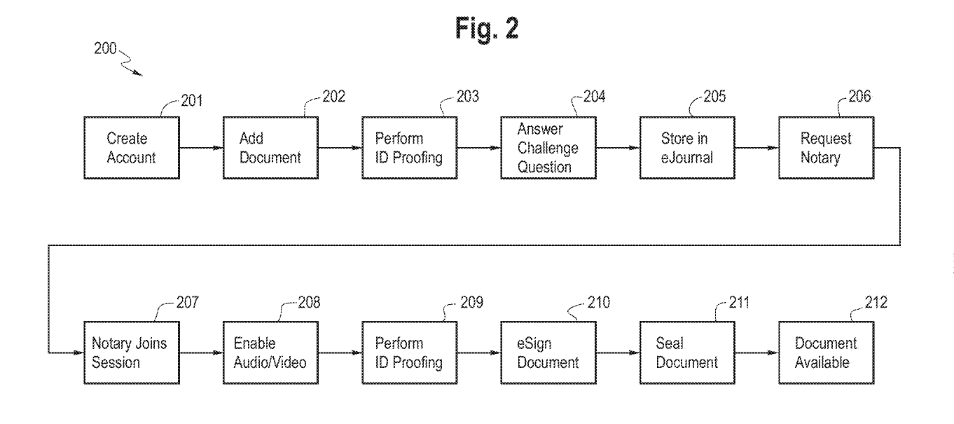

FIG. 2 illustrates an example of a remote notary session 200 in an embodiment. In step 201, a client account is created via client computer 10 accessing remote notary 20, including first name, last name, email address, password, and a password confirmation. Additionally, a consent may be required for electronically signing and also to use a webcam. In step 202, a document to be executed is provided to the remote notary system 20. One or more documents may be uploaded or downloaded. In other embodiments, documents may be submitted electronically so that multiple signers can share, review, approve, edit, comment, and engage with the notary at the same or substantially same time. In other embodiments, a transaction ID may be created and applied and/or associated to a document and may be repeated as necessary. It should be noted that a notary may initiate a notary session, add the document to be notarized, invite a signer, and/or perform identity proofing.

In step 203, the system 20 receives a client's personal information in order to perform identity proofing, such as knowledge-based authentication (KBA), which may be static or dynamic. Other identity proofing techniques may be used in combination or separately. In step 204, the system may include a signatory answering one or more automated challenge responses Step 204 may be optional. In step 205, the results of step 204 may be stored in an electronic notary journal of system 20. In step 206, the system requests a notary to the session. In step 207, the notary computer joins the session. In step 208, the notary computer enables video and/or audio recording. In step 209, dynamic or static KBA may be performed and a video capture of a physical identification. Other identity proofing techniques may be used in combination or separately. In step 210, the document is electronically signed. In step 211, the document is electronically stamped and sealed using a digital certificate. Other security techniques may include blockchain, evault, registry, custodian information, passwords, personal identification numbers (PIN), multifactor authorization (MFA) and watermarking. In step 212, the document is available for download.

In some embodiments, remote notarization may be performed in combination with a remote electronic closing of a transaction, such as a real estate transaction, purchases or sales, and wire transfers in this embodiment, the system may provide safe harbor, including blockchain, distributed ledger, and/or Mortgage Electronic Registration Systems (MERS) eRegistry either directly or through third party APIs. In such systems, an electronic closing and/or an electronic registration may be performed remotely and electronically without having the signer and notary meet in person or having paper forms changing hands in an integrated, paperless transaction. Any type of document may be configured for use including promissory notes, mortgage related documents, advanced health directives, postal forms, living wills, power of attorney, passports, immigration forms, IRS forms, employment related forms, marriage or divorce forms, credit forms, such as debt credit counseling or consolidation, surrogacy adoption forms, professional license credential certification forms, mortgage related forms, parent authorization, and/or auto titles. Documents may also be associated with banking, mortgage, trusts/wills, identity proofing, legal, digital transaction management, vital records, background checks, finance companies. U.S. embassies, passports, identity theft remediation, correctional facilities, and the postal service.

In some embodiments, the system 20 may invoice and collect payment from the signatory or other third party. In some embodiments, the system 20 may also provide payment to the notary.

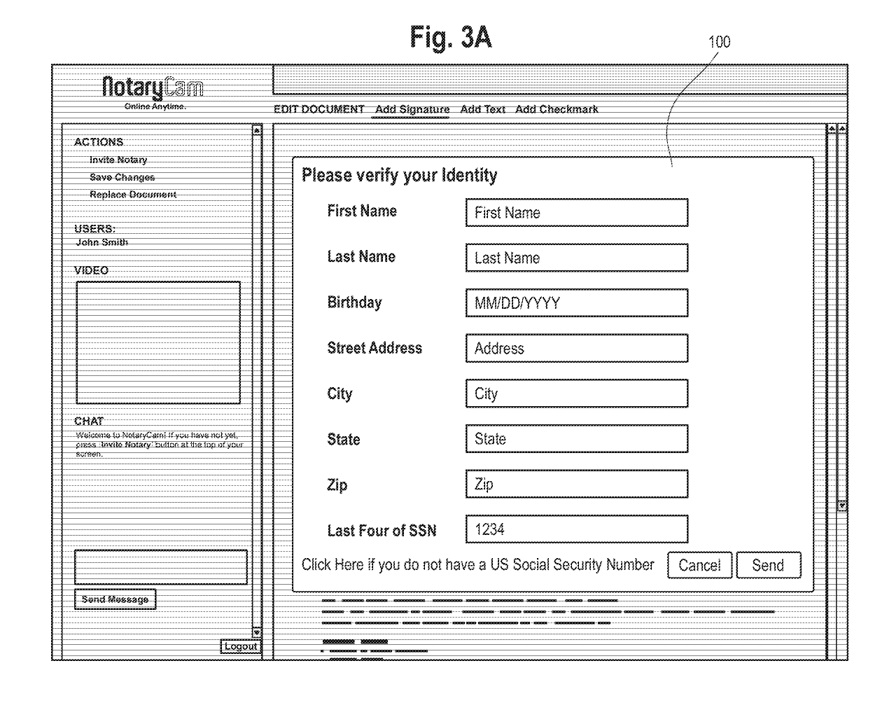

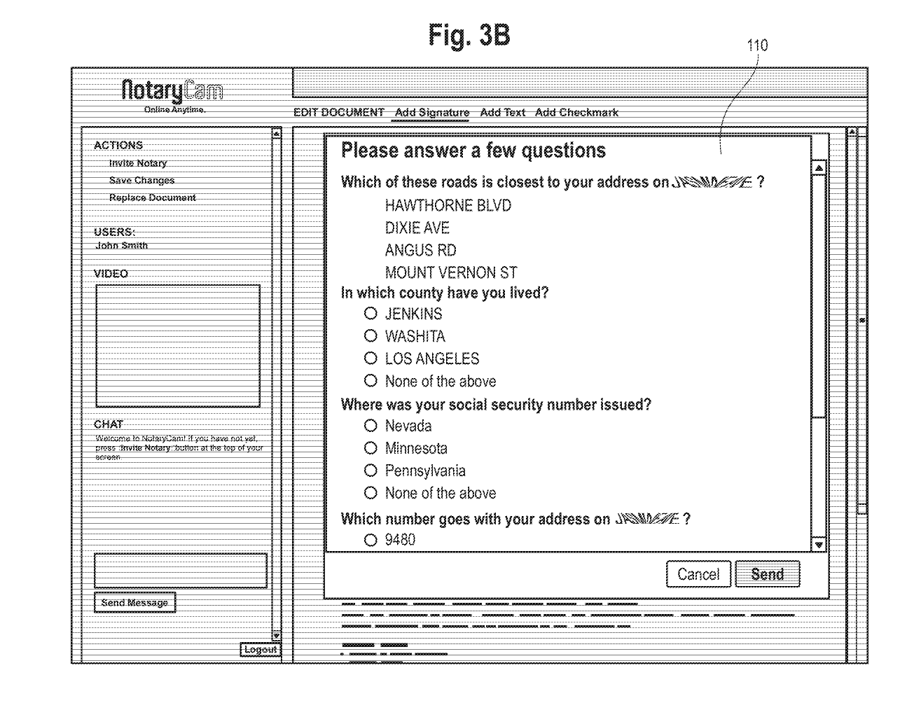

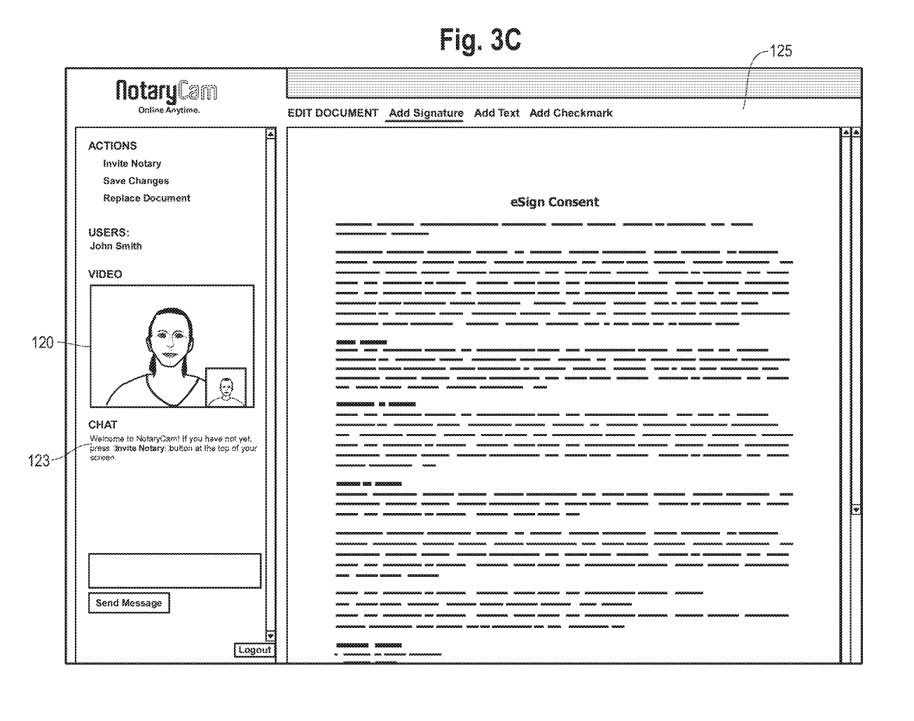

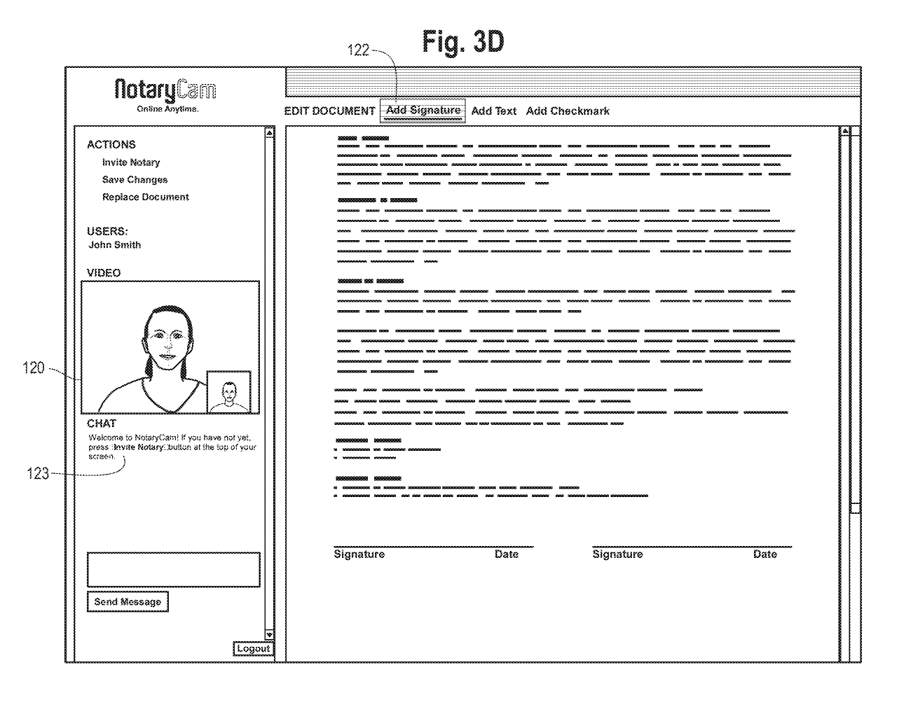

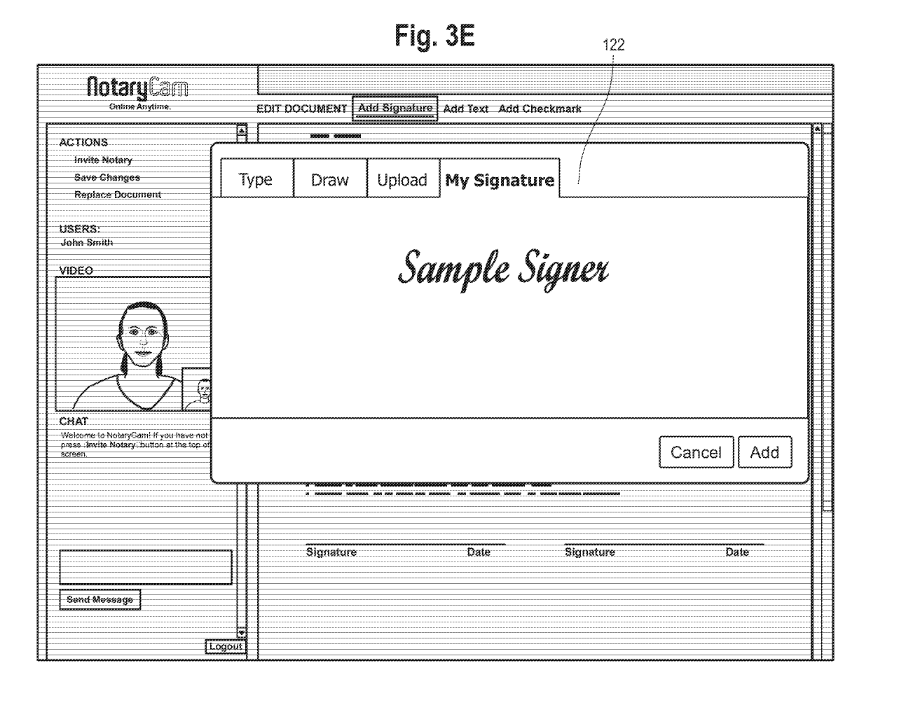

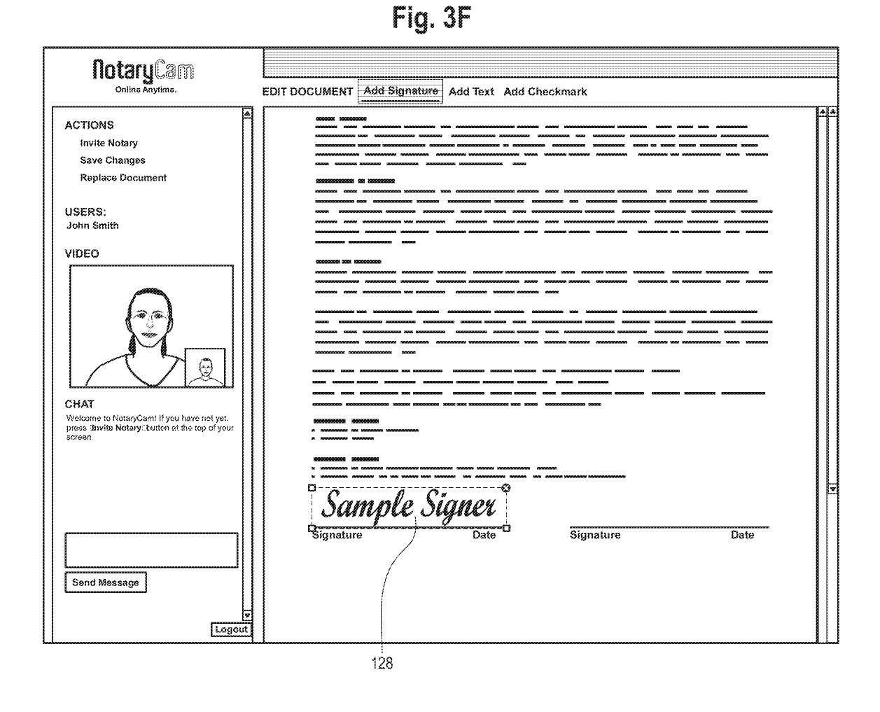

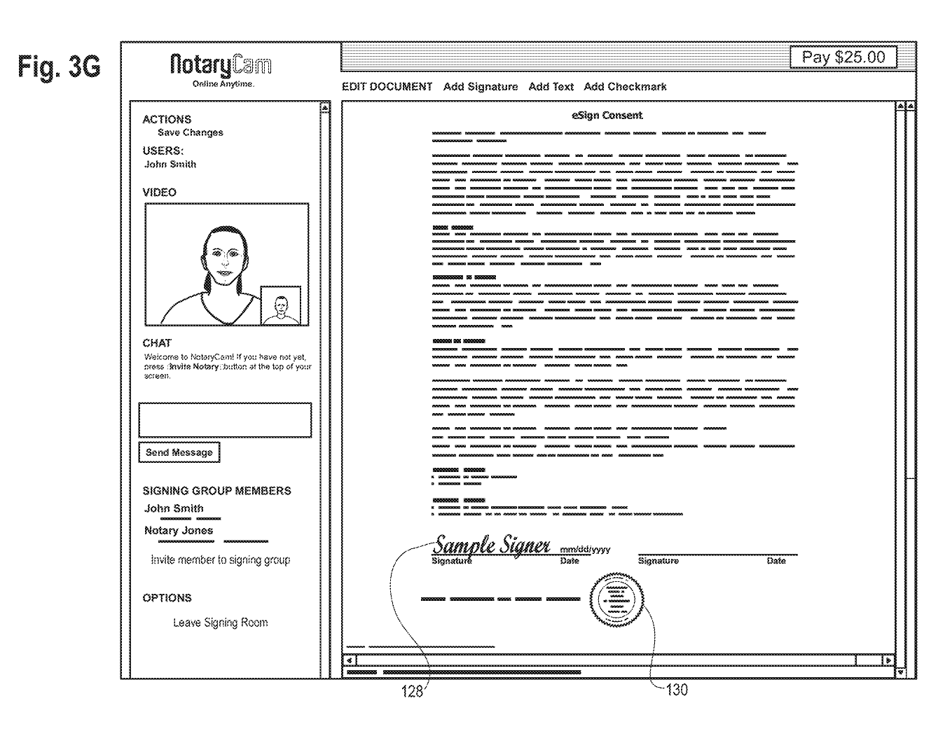

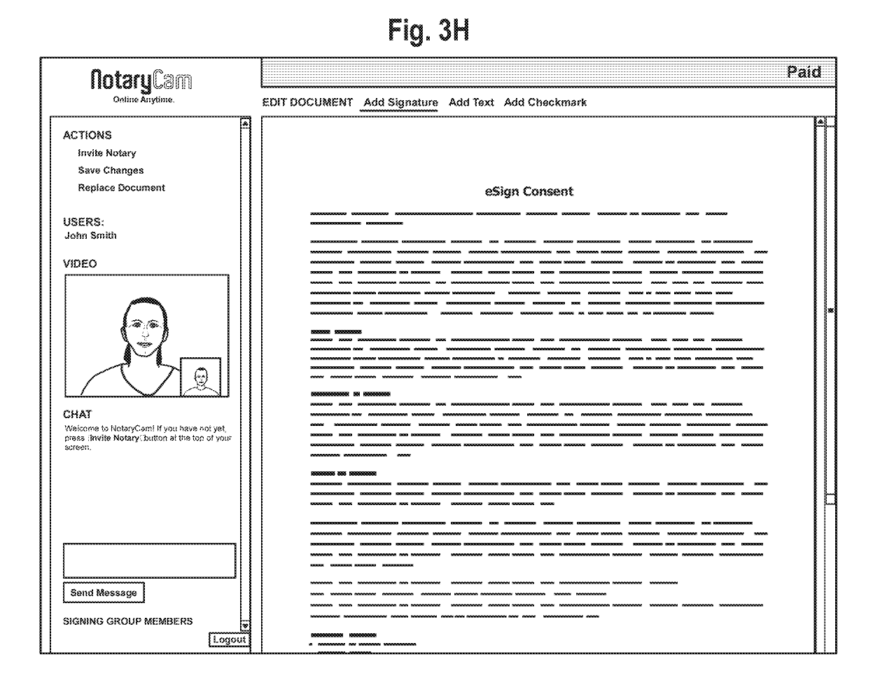

FIGS. 3A-3J illustrate screen shots of a remote notary session. As shown in FIG. 3A, the system may receive as input identification information about a signatory in screen 100. FIG. 3B shows the KBA screen 110 as a series of challenge questions that are automatically served once the login is validated. FIG. 3C illustrates a video feed for a notary 120 and a text box 123 for sending instant or text messages from the notary. The text box may be populated using a keyboard or using a voice input. A text box substantially the same as text box 123 may be included for the signatory to communicate with the notary. Additionally, a video feed of the signatory may be included. A consent form 125 may be provided for the signatory. In FIG. 3D, the system may provide one or more options for the signatory including a button 122 for adding an electronic or digital signature. In other embodiments, a button to edit the document, add text, and/or add a check mark may also be included.

FIG. 3E shows that the system may receive an electronic signature 128 from the signatory. FIG. 3F shows the electronic signature 128 inserted in the document. FIG. 3G illustrates an electronic seal 130 added to the electronic document. Digital signatures and/or electronic signatures may also be added. An invoice may also be created. In FIG. 3H, the electronic document may be provided to the signatory in any means possible for sending electronic documents, including over the Internet, by secure encrypted electronic mail, by SMS, by file sharing, portal or over a private network. In one embodiment, the notary may upload the document to the signatory during the same remote notary session. FIG. 3I shows a multi-signer embodiment in which a second electronic signature 138 may be added to the same document, after signature 128 is added to the document. The signatures may be the same or different. Initials or other text may also be added.

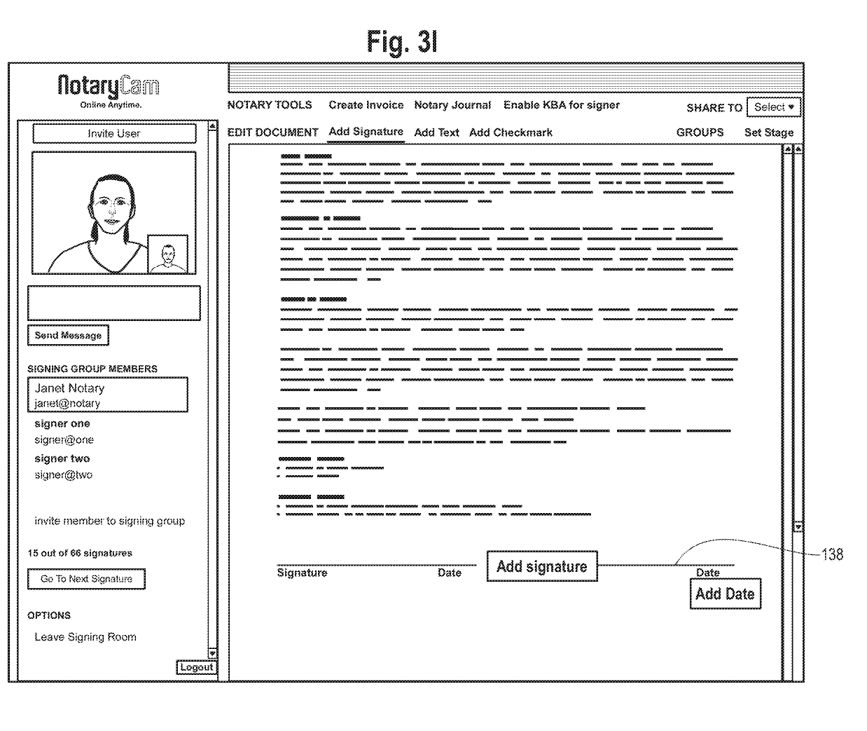

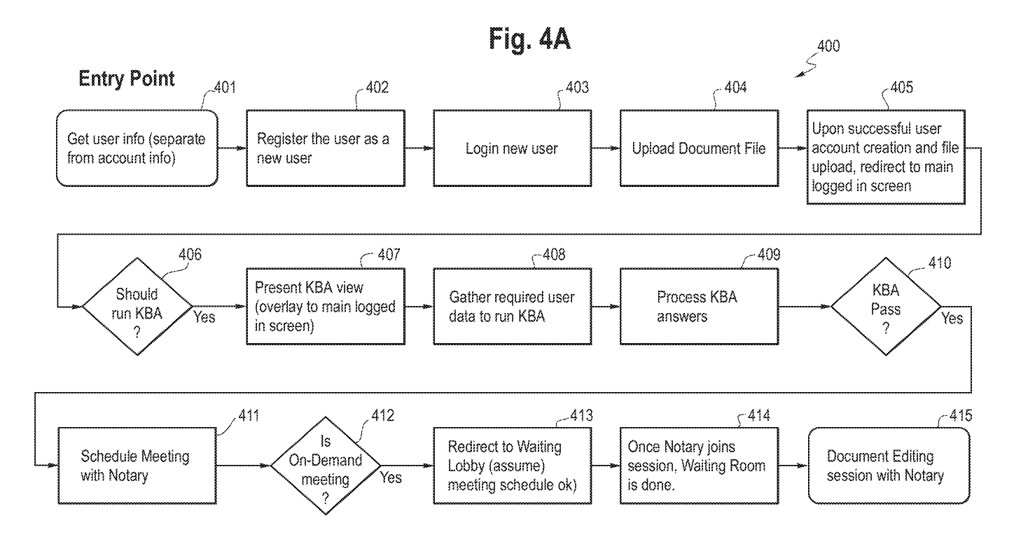

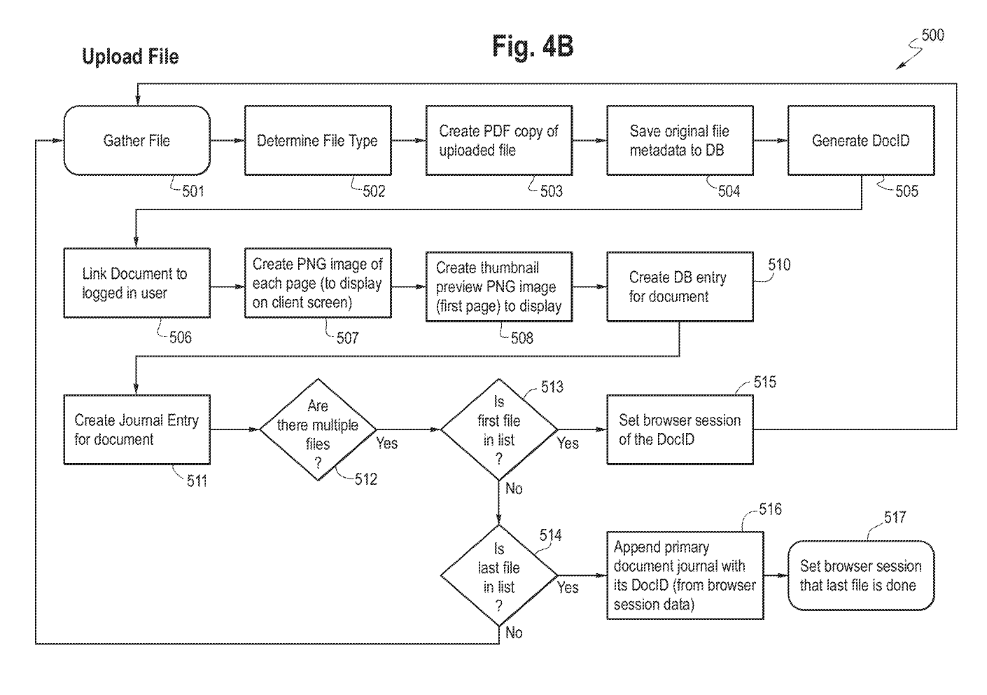

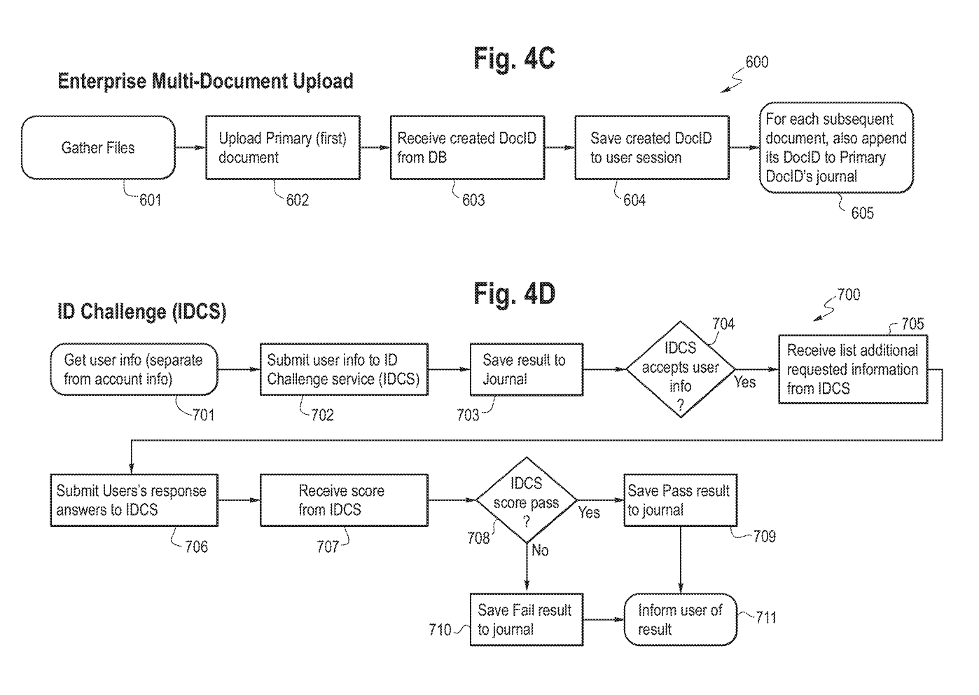

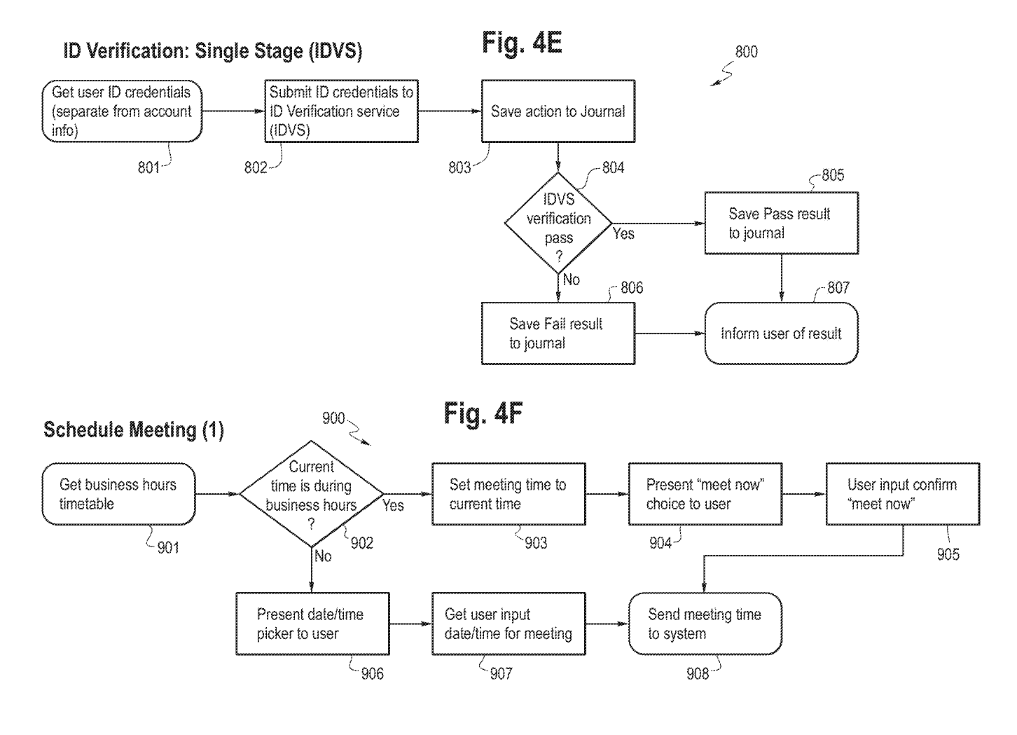

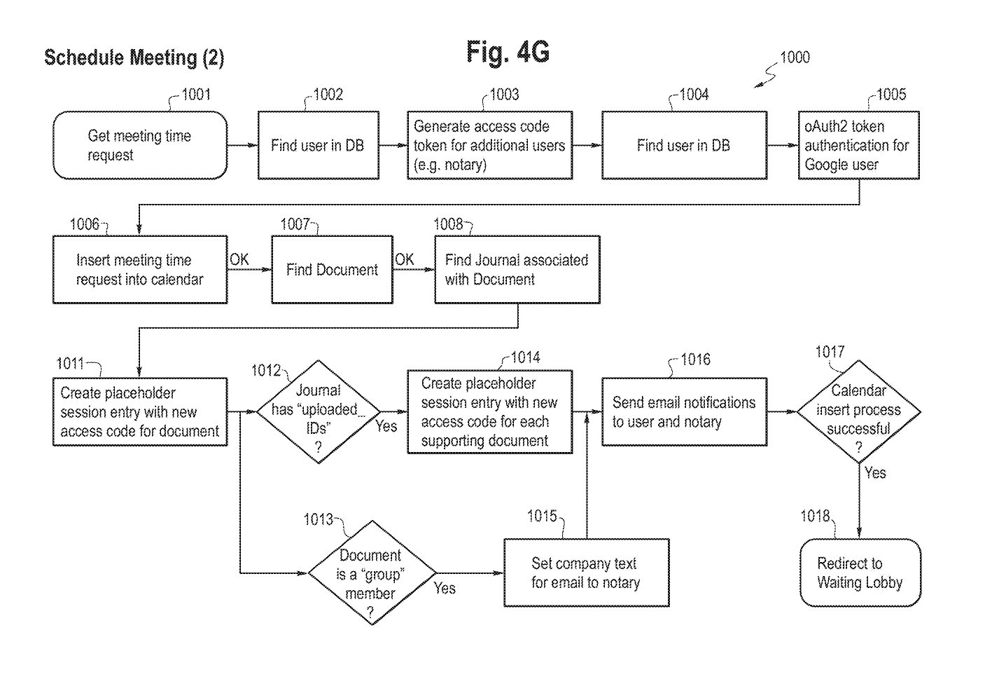

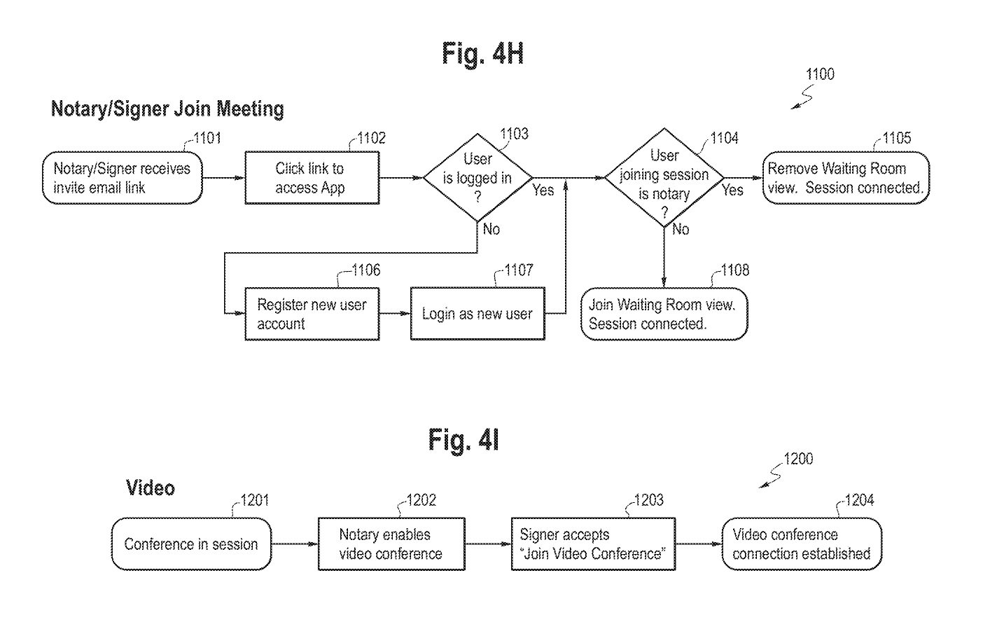

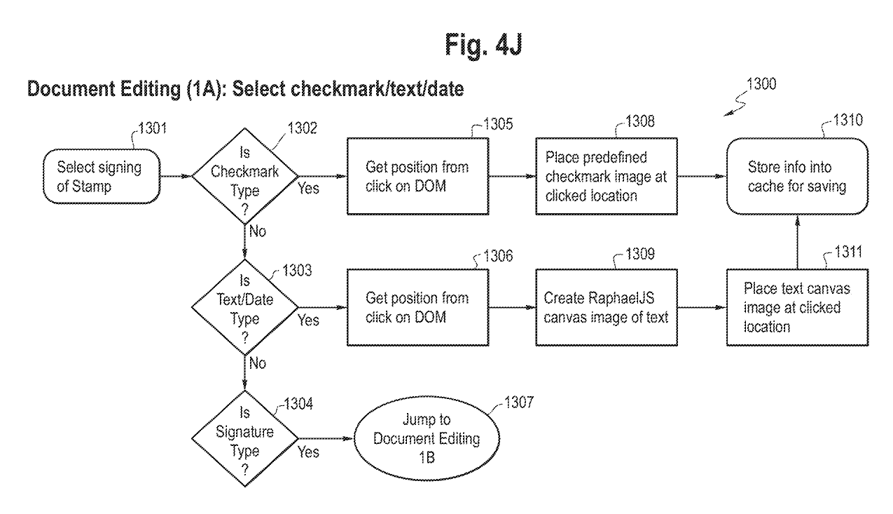

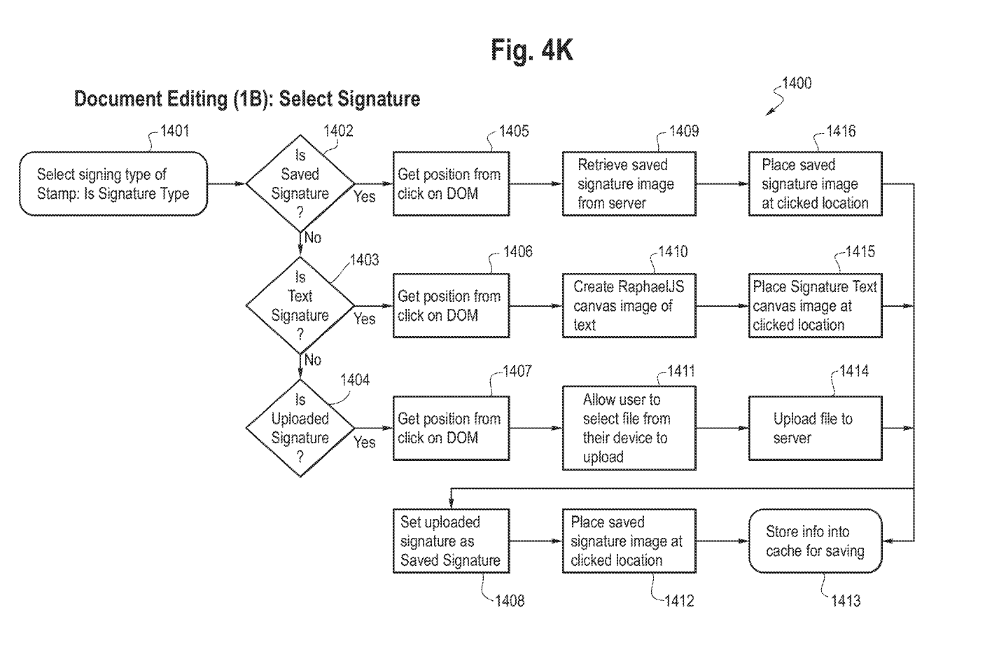

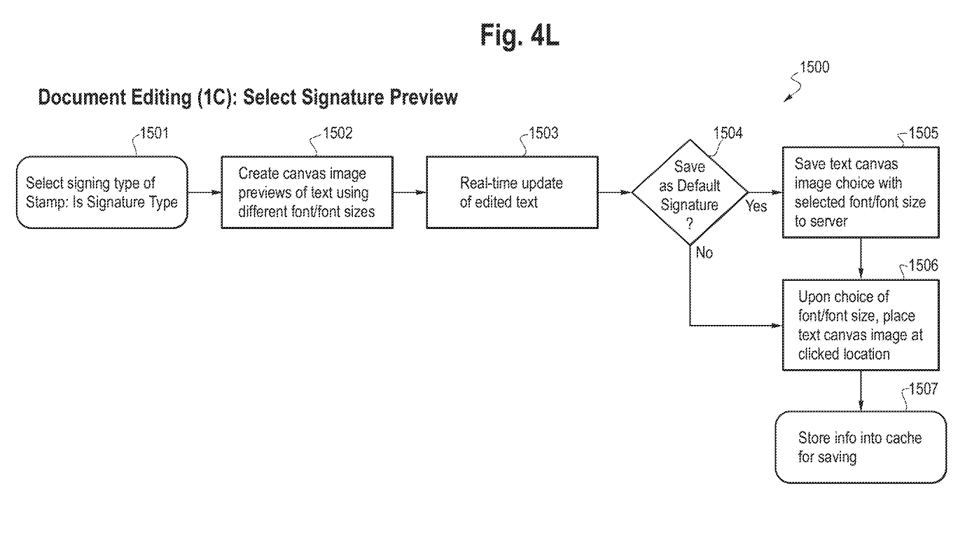

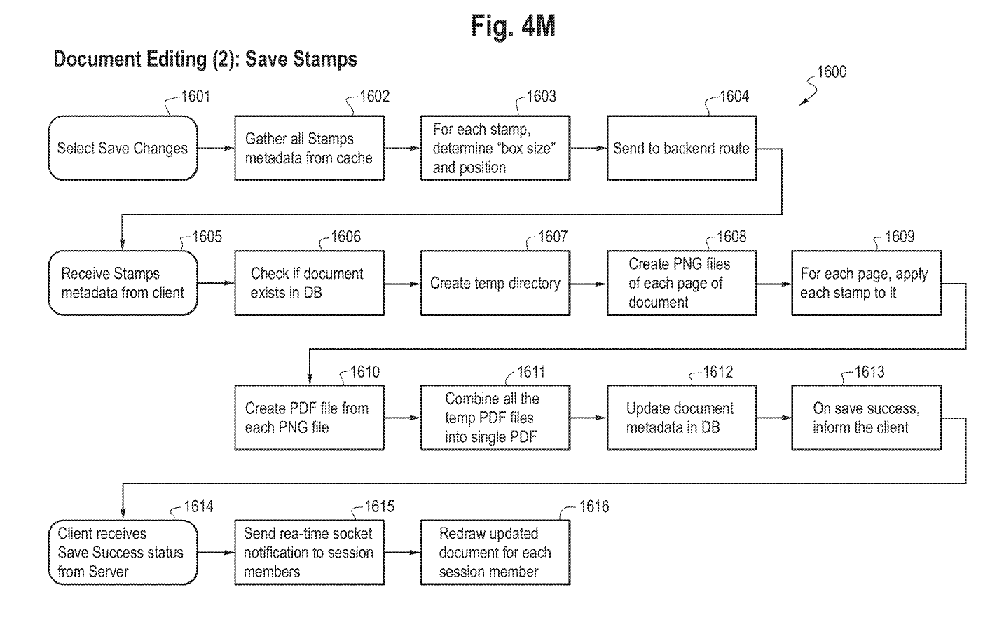

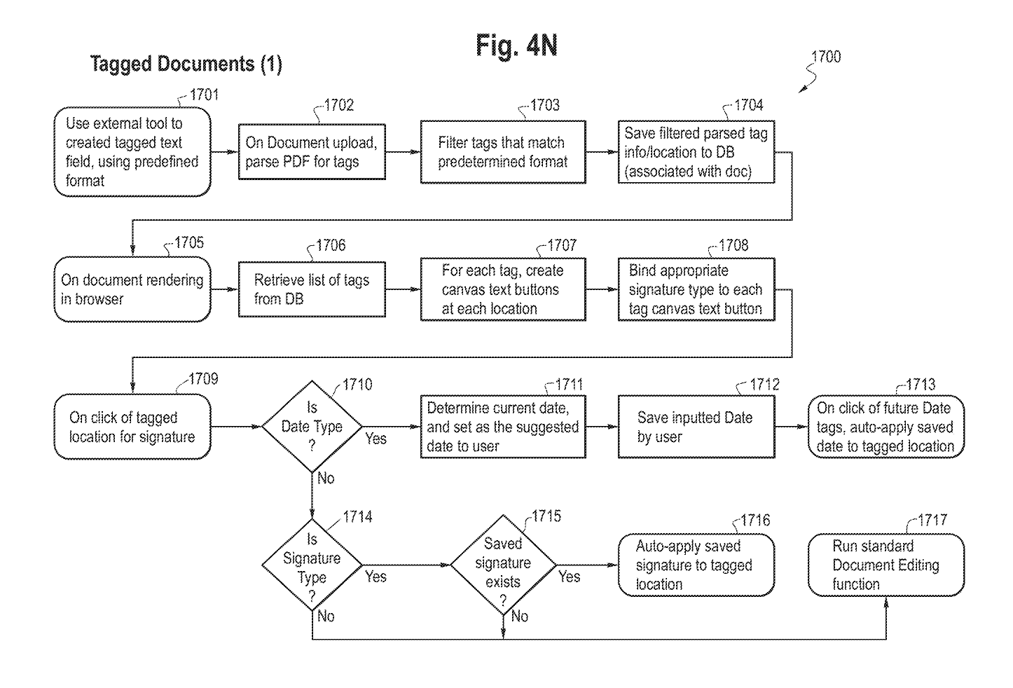

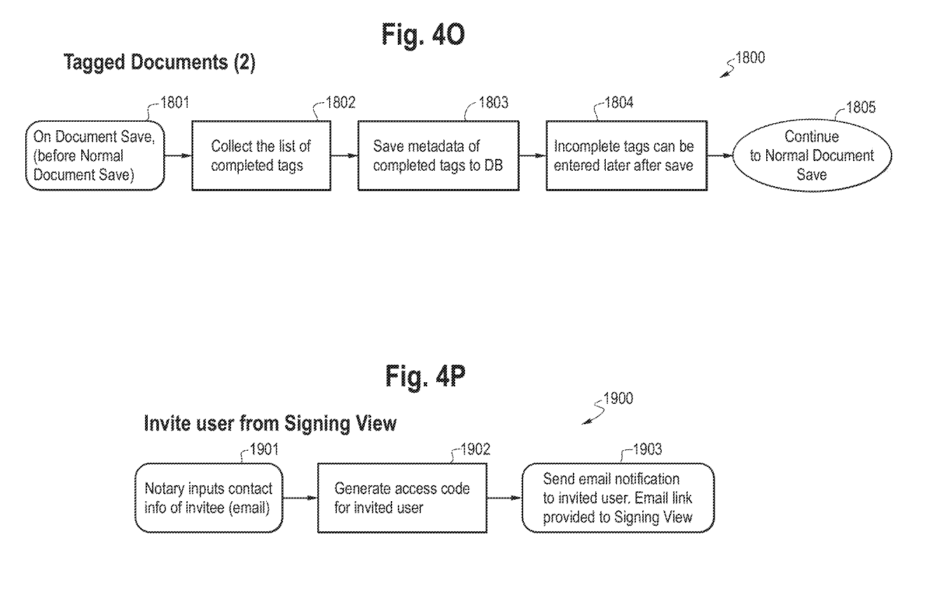

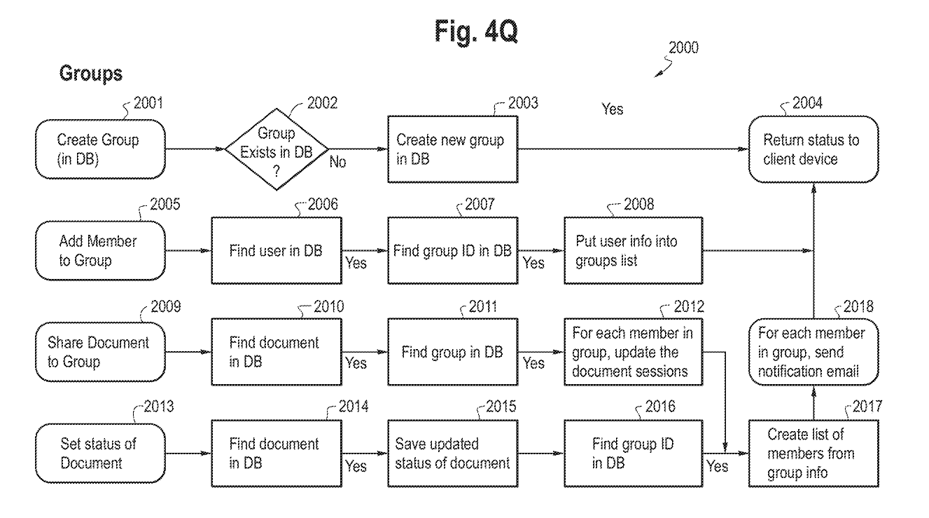

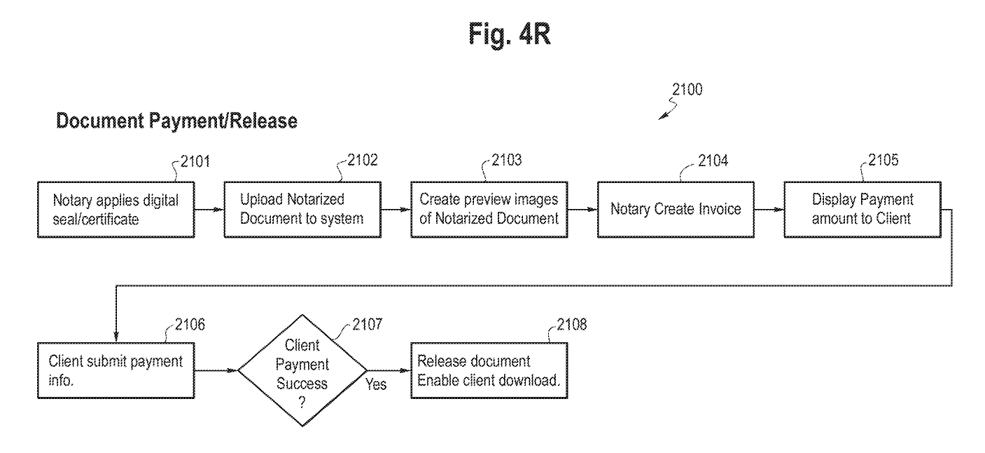

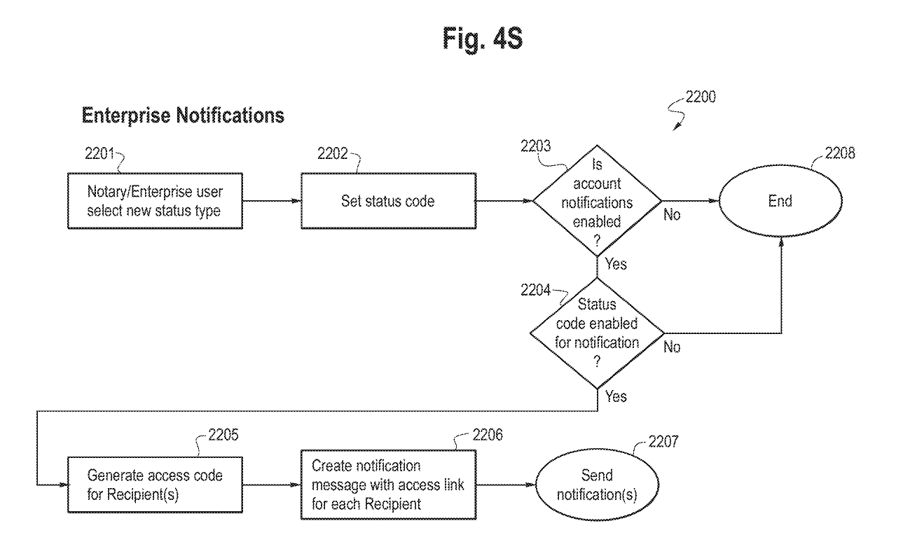

FIG. 4A illustrates a flow chart for an execution of a remote notary session. At 401, the system may receive information about a signatory. At 402-404, the system may validate the user, enable the user to login, and upload a file, respectively. In some embodiments, a link may be sent to a user without requiring a user to register or enter any credentials. In some embodiments, the link may expire after a certain number of uses or a certain amount of time. At 405, the system may redirect the signatory to an automatic serving of KBA questions to be answered by the signatory. Once the system processes and validates the KBA answers at 407-410, the system may schedule an on-demand notary session with a remote notary over a secure network connection at 411-415. Alternatively, additional forms of identity proofing may be performed prior to scheduling the on-demand session. In one embodiment as shown in 412-414, the communication session between the notary and the signatory may be initiated. Optionally, before or after 411, credential analysis, biometrics, 3rd party databases may be used for additional identity verification.

FIG. 4B shows a flow 500 for uploading an electronic document or file. It should be noted that the remote notary system may be configured to handle any form of electronic digital file type. At 501, one or more files or documents may be uploaded, gathered, or created. At 502-505, the file type of the document is determined, a .pdf file is created, meta data associated with the electronic document are stored in the database, and a document identification (DocID) are generated, respectively. At 506, the document is linked to the logged in user and a PNG of each page occurs in 507-509. A database entry for the document is created at 510. At 511, an electronic journal entry may be created for one or more files 512-13. In 515, the browser session of the DocID is set for the first file and the process repeats at 501 for the next file. When the last file is found in the list of files at 514, the DocID is appended in 516 and the browser session is set at 517.

FIG. 4C shows a multi-document upload 600. The files are gathered may be or created at 601, the first document may be uploaded at 602, a docID may be received at 603, stored at a user session at 604, and the docID or a transaction ID may be appended to a journal entry at 605. In other embodiments, at 601, a transaction may be created, and a transaction ID may be received. In other embodiments, at 604, information associated with the document may be saved.

FIG. 4D shows a flow for an identification (ID) challenge 700. At 701, the system accepts user information that may include any personal information required by an identification check provider. Examples may include birthday, address, social security number, biometrics, two-factor authentication code, name, email, phone, payment information, and/or esign acknowledgement.

At 702, the system submits the user information to a third-party service that may process KBA. The user information may be stored at 703 in an electronic journal. At 704 and 705, the third-party service may require additional information about the signatory or receive a submission of responses at 706. The system then receives a score 707 and then determines a pass score at 708. Should the user fail, the result may be stored in an electronic journal at 710 and the result may be passed to the user at 711. In contrast, if the score passes, at 709, the score is saved in an electronic journal and sent to the user at 711.

FIG. 4E illustrates a single stage ID verification 800. At 801, the system accepts ID credentials. At 802, the ID credentials are verified, and the action saved to the journal at 803. In the alternative, the identity may also be stored in a blockchain, evault, or the like. At 804, it is determined if the verification passes and the results are recorded at 805 and 806, respectively, and the result is transmitted to the user at 807. At 804, multi-factor idvs, acceleration or mandatory additional idvs, may be used. Additionally, IDVS man be processed prior to session or during live session. Other ID verification services (IDVS) may be used.

FIG. 4F shows a process for scheduling a meeting 900 in an embodiment. At 901, the system receives the availability of a notary and determines if the notary is capable of meeting at a time. If yes, the system sets an on-demand or substantially real time meeting with the signatory at 903-905. Once the meeting is confirmed by the signatory, the meeting time is confirmed at 908. If the notary is not available, the time is agreed at a later time at 906-907 and confirmed at 908.

FIG. 4G shows a process for scheduling a meeting 1000 in an alternative embodiment. At 1001, a meeting time request is received, and an associated user is found in the database 1002. At 1003, one or more tokens may be generated for each user to the notary session, and a user may be found and authenticated in 1004 and 1005, respectively. At 1006-1008, the meeting time may be inserted into a calendar, the document to be executed found, and the journal entry for the document found, respectively. At 1011: an access code is created in order for the notary to access the document. The access code may be generated and embedded into a link, which access the document. At 1012: a check for supporting documents, such as identification information, that are associated with the primary document is performed. An access code may also be created for each supporting document to be accessed by the system. At 1013: the document may be shared with an organization that requests notifications i.e. “groups.” At 1016, email notifications may be sent to participants in the notary session, the calendar entry is determined to be successful at 1017, and the process is directed to the waiting room, as described herein.

FIG. 4H shows a process for a notary and signer to join a meeting 1100. At 1101, the participants to the remote notary receive a link to access the session in 1102. If the user is logged at 1103, the user is connected to the waiting room. If at 1104, the notary is available, then the communication is established. If the notary is not yet available, the user is joined to the waiting room to wait for the notary at 1108. If at 1103 the user is not logged in, the user is registered at 1106 and logged in at 1107. In some embodiments, a link may be sent to a user without requiring a user to register or enter any credentials. In some embodiments, the link may expire after a certain number of uses or a certain amount of time.

FIG. 4I shows a process for a video session 1200. The system determines if a conference has been initiated at 1201. At 1202, the system may enable the video conference, or a notary may enable the conference. At 1203, the signatory may automatically join the video conference or manually join at 1203. At 1204, the parties may be connected over a live video feed. In some embodiments, an on-demand session may enable step 1201 to proceed to 1204 directly.

FIG. 4J illustrates a document editing process 1300. If the type is a checkmark at 1302, the position for the checkmark is located at 1305, the mark is placed at the defined location in 1308, and the data associated with the mark is stored at 1310. If the type is text at 1303, steps 1306, 109, and 1311 occur in substantially the same way as 1305, 1308, and 1310, respectively.

FIG. 4K illustrates a document editing process 1400 in an embodiment. At 1401, the electronic or digital signature type is determined. If the signature is saved at 1402, the position for the signature is selected at 1405, the signature is retrieved at 1409, and is saved at a clicked location of the image at 1416 and stored at 1413. If the signature is a text signature at 1403, the position is selected at 1406. An image of the text signature is created at 1410 and the signature is placed on the image at 1415 and saved at 1413. If the signature is uploaded at 1404, the position is generated at 1407, and a device from where the signature is to be uploaded may be selected at 1411. At 1414, the signature may be uploaded to the server, the uploaded signature may be saved as a saved signature 1408, and the saved signature may be saved at a clicked location at 1412 and stored at 1413. In other embodiments, the signature may be a holographic signature created inside the application. In other embodiments, the signature may be drawn on a screen, auto-set as a saved signature, and/or the font size may be changed.

FIG. 4L illustrates a document editing process 1500 in an embodiment. At 1501, the text type may be selected and a preview of different font and font sizes at 1502. A real time or substantially real time update may be received at 1503. At 1504, if the signature is a default signature, the text signature is saved at 1505, applied at a clicked location at 1506, and stored at 1507. If the text signature is not the default signature, 1504 proceeds to 1505 and 1506. It should be noted that one or more of the fields may be pre-filled by receiving a https communication payload.

FIG. 4M illustrates a document editing process 1600 in an embodiment. In one embodiment, the select save changes is selected at 1601, metadata for the stamps are gathered at 1602, a box size is determined for each stamp at 1603. At 1604, the document is sent to the server for processing. At 1605-1606, it is verified if the document exists in database. At 1607, a temporary working directory may be provided. At 1608, for each page of the document, an image version of each page (e.g., in PNG format) may be formed. In other embodiments, the document may be edited directly, such as edited directly on a .pdf. At 1609, from the stamps metadata list, get the stamps for a certain page, and apply them to the image. At 1610, a pdf file may be created from each update image with stamps. At 1611, a single file may be formed from the pages. At 1612, an update to the document metadata in the database may occur. At 1613, on successful database save, the client device may be informed. At 1614, from the client-side, the save success status may be received. At 1615, real-time notifications may be sent to one or more devices that the document has been updated. At 1616, the updated document may be redrawn.

FIG. 4N illustrates a document tagging process 1700 in an embodiment. At 1701-04, the document may be parsed for tags or form fields and filtered that may match a predetermined format, and the tags may be saved to the database. In other embodiments, tagged documents may be received from other sources and also coordinates of those tagged documents may be determined by the system.

The document may be rendered at 1705, and a list of the tags from the database may be retrieved at 1706. At 1707, for each tag, canvas text button(s) may be created for each tag. A signature may be applied to each text button at 1708. At 1709, the tagged signature button may be accessed. At 1710, if the tag type is a “Date”, then at 1711, determine the current date and set as the suggested date. At 1712, the system may accept the suggested date or provide a desired date and save the result. At 1713, in subsequent “Date” tag locations, the saved date result may be automatically applied. At 1714, if the tag type is a “Signature”, and at 1715, is there exists a signature previously saved, at 1716, automatically apply the saved signature to the tagged location. At 1717 the stamps processing functions may be executed on both client and server side. In other embodiment, real-time tagging may be performed wherein the seal is applied during the real-time audio/video session. In other embodiments, tags may be added for different signers during tagging of the document.

FIG. 4O illustrates a document tagging process 1800 in an embodiment. At 1801, on an initial document save, the list of tags is collected at 1802. The metadata is saved at 1803. At 1804, the incomplete tags may be saved and/or entered, and the normal save may continue.

FIG. 4P illustrates an invitation process 1900 in an embodiment. In one embodiment, contact information may be received at 1901 and an access code may be generated at 1902. An email link may be provided at 1903 for signing.

FIG. 4Q illustrates a group process 2000 in an embodiment. In one embodiment, a group process may enable for sending automated notifications to members of a group that is associated with a transaction. A group may be created and/or add members may be added to an existing group at any time prior, during, or after a transaction. A document status, e.g. “complete”, or “in progress” may be set. A notification may then be sent to alone or more members of the group. Alternatively, if there is no status change, a notification may also be sent.

Referring again to FIG. 4Q, a group may be created in a database, as shown in steps 2001-2004 and 2017-2018. A member may be added to a group as shown in steps 2005-2008 and 2017-2018. A document may be shared with members of the group, as shown in steps 2009-2012 and 2017-18. A status of the document may be set, as shown in steps 2013-16 and 2017-18.

FIG. 4R illustrates a document payment and/or release process 2100. At 2101, a notary seal or certificate may be applied. At 2102, the preview images of the notarized document may be generated at 2103. An invoice may be created at 2104 and the amount may be displayed at 2105. At 2106, the client may submit payment and the payment may be confirmed at 2107. If the payment was successful at 2107, the document may be released at 2108.

FIG. 4S shows a process 2200 for enterprise notifications in an embodiment. In an embodiment, this process may replace the process shown in FIG. 4Q. At 2201, a notary or enterprise user may select a new status type. A status type may include a code for an action that can be used to track the status of the different actions during various parts of the notary session. A status code may be set at 2202. If account notifications are not enabled at 2203, the process ends at 2208. If notifications are enabled, it is determined if the status code is enabled to notification at 2204. That is, notifications may be sent based on the status code to cause additional actions or to report a status of the document to an enterprise. If no, the process ends at 2208. If yes, then an access code is generated for the recipient at 2205, a notification message is created with an access link per recipient at 2206, and a notification is sent at 2207.

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. An apparatus for processing a remote transaction between a first and second user including an electronic document including a processor configured to execute a plurality of instructions stored in a memory coupled to the processor, the processor configured to process the transaction in real time or substantially real time, the instructions comprising:
initiating by the processor a communication with a first computing device over a network;
receiving by the processor an electronic document to be notarized or witnessed over the network;
one of the first user being online or not being online, authenticating by the processor an identification of the first user electronically executing the document, the authentication further comprising automatically serving to the first user one or more knowledge based questions and if responses to the one or more knowledge based questions are correct, establishing by the processor on-demand a real-time audio and video communication between the first user and second user;
initiating by the processor an online identification proofing of the first user by the second user including authenticating by the processor one or more identification-related forms of the first user and if the identification proofing is confirmed by the processor, affixing by the processor an electronic signature to the electronic document; and notarizing and securitizing by the processor the electronic document.

2. The apparatus of claim 1 wherein the securitizing further comprises one of blockchain, evault, registry, custodian account, passwords, personal identification numbers (PIN), multifactor authorization (MFA) and watermarking.

3. The apparatus of claim 1 wherein the identification proofing further comprises biometrics.

4. The apparatus of claim 1 wherein the instructions further comprise storing by the processor an identification number or a transaction number associated with the electronic document in an electronic journal, blockchain or ledger.

5. The apparatus of claim 1 wherein the identification proofing comprises a multi-factor authentication.

6. The apparatus of claim 1 wherein the initiating by the processor a communication with a first computing device over a network further comprises initiating by the processor a communication with a second computing device to enable a third user to electronically sign the electronic document.

7. The apparatus of claim 1 wherein the instructions further comprise making available to the first user the electronic document.

8. The apparatus of claim 1 wherein the electronic document is configured to be edited by the first and second user over the network.

9. The apparatus of claim 1 wherein the automatically serving to the first user one or more knowledge-based questions includes serving to the first user one or more knowledge-based questions dynamically, wherein the one or more knowledge based questions is served in real-time based on the identification of the first user and randomized from a plurality of sources and a response to the one or more knowledge based questions is non-weighted.

10. The apparatus of claim 1 wherein the instructions further comprise recording the real-time audio and video communication between the first user and second user

11. The apparatus of claim 1 wherein the instructions further comprise issuing metadata from the transaction.

12. A computerized method for processing a remote transaction between a first and second user including an electronic document, the processing occurring in real time or substantially real time, the method comprising:
initiating by the processor a communication with a first computing device over a network;
receiving by a processor an electronic document to be notarized or witnessed over the network;
one of the first user being online or not being online, authenticating by the processor an identification of the first user electronically executing the document, the authentication further comprising automatically serving to the first user one or more knowledge based questions and if responses to the one or more knowledge based questions are correct, establishing by the processor on-demand a real-time audio and video communication between the first user and second user;
initiating by the processor an online identification proofing of the first user by the second user including authenticating by the processor one or more identification-related forms of the first user and if the identification proofing is confirmed by the processor, affixing by the processor an electronic signature to the electronic document; and
notarizing and securitizing by the processor the electronic document.

13. The method of claim 12 wherein the securitizing further comprises one of blockchain, evault, registry, custodian account, passwords, personal identification numbers (PIN), multifactor authorization (MFA) and watermarking.

14. The method of claim 12 wherein the identification proofing further comprises biometrics.

15. The method of claim 12 further comprising storing by the processor an identification number or a transaction number associated with the electronic document in an electronic journal, blockchain or ledger.

16. The method of claim 12 wherein the identification proofing comprises a multi-factor authentication.

17. The method of claim 12 wherein the initiating by the processor a communication with a first computing device over a network further comprises initiating by the processor a communication with a second computing device to enable a third user to electronically sign the electronic document.

18. The method of claim 12 further comprising recording the real-time audio and video communication between the first user and second user.

19. The method of claim 12 wherein the electronic document is configured to be edited by the first and second user over the network.

20. The method of claim 12 wherein the automatically serving to the first user one or more knowledge-based questions includes serving to the first user one or more knowledge-based questions dynamically, wherein the one or more knowledge based questions is served in real-time based on the identification of the first user and randomized from a plurality of sources and a response to the one or more knowledge based questions is non-weighted.
